(19) United States
(12) Patent Application Publication
(10) Pub. No.: US 2022/0137197 A1
(43) Pub. Date: May 5, 2022

(54) ROBUST EYE SAFETY FOR LIDARS

(71) Applicant: Motional AD LLC, Boston, MA (US)

(72) Inventors: Michael Maass, Pittsburgh, PA (US); Maria Antoinette Meijburg, Boston, MA (US); Karl Robinson, Norwell, MA (US)

(21) Appl. No.: 17/086,273

(22) Filed: Oct. 30, 2020

(51) Int. Cl. G01S 7/4914; G01S 17/89

(52) U.S. Cl. CPC G01S 7/4914; G01S 17/931; G01S 17/89

(57) ABSTRACT

Among other things, systems and techniques are described for LiDAR (Light Detection and Ranging) safeguards. A described technique includes receiving, at a LiDAR's spinning unit from the base unit, a command to activate a laser; obtaining, at the spinning unit, a measurement from a sensor to detect rotation of the spinning unit in the rotational plane; determining, at the spinning unit, whether a rotational speed of the spinning unit is greater than or equal to a minimum rotational speed threshold based on the measurement; and activating, at the spinning unit, the laser to produce output in response to the command based on a determination that the rotational speed of the spinning unit is greater than or equal to the minimum rotational speed threshold.

### FIELD OF THE INVENTION

This description relates to LiDAR (Light Detection and Ranging) technology.

### BACKGROUND

LiDAR is a technology that uses a laser and imaging circuitry to obtain data about physical objects in its line of sight. A LiDAR system can produce LiDAR data. LiDAR data can include a collection of three-dimensional (3D) or two-dimensional (2D) points that are used to construct a representation of the environment surrounding the LiDAR system.

### BRIEF DESCRIPTION OF THE DRAWINGS

FIG. 1 shows an example of an autonomous vehicle having autonomous capability.

FIG. 2 shows a computer system.

FIG. 3 shows an example architecture for an autonomous vehicle.

FIG. 4 shows an example of inputs and outputs that can be used by a perception module.

FIG. 5 shows an example of a LiDAR system.

FIG. 6 shows the LiDAR system in operation.

FIG. 7 shows the operation of the LiDAR system in additional detail.

FIG. 8 shows an example of an architecture of a LiDAR system that includes a spinning unit and a base unit.

FIG. 9 shows an example of an architecture of the LiDAR base unit.

FIG. 10 shows an example of an architecture of the LiDAR spinning unit.

FIG. 11 shows another example of an architecture of a LiDAR spinning unit.

FIG. 12 shows a flowchart of an example of a process that performs a safety check before activating the laser of a LiDAR.

### DETAILED DESCRIPTION

In the following description, for the purposes of explanation, numerous specific details are set forth in order to provide a thorough understanding of the present invention. It will be apparent, however, that the present inventions may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. Autonomous Vehicle Architecture

4. Autonomous Vehicle Inputs

5. LiDAR Safety Mechanism

### General Overview

Spinning-type LiDAR technology performs 360 degree scanning by continuously rotating a spinning unit of the LiDAR, which contains a laser and optical sensor. This disclosure includes techniques and systems for laser safeguards for such technology, including safeguards to ensure that a LiDAR's spinning unit is greater than or equal to a minimum rotational speed before operating the laser upon command from the LiDAR's base unit, or to suspend laser operations in the event that the unit slows or stops spinning. One or more of the described techniques and systems can use a low-cost rotation detection sensor (e.g., a gyro) within the spinning unit to determine that the minimum rotational speed is met before activating the laser.

A spinning-type LiDAR typically employs a laser having a power output that may be harmful to the human eye and sensitive electronic devices such as digital cameras if the spinning-unit stops spinning. For example, for 1550 nanometer wavelengths, a spinning laser is considered safe to the human eye and thus satisfies federal and industrial safety guidelines. However, if the laser stops rotating and continues to beam in one particular direction, the laser could cause ocular harm.

The techniques and systems described herein can automatically prevent or suspend laser operations when a rotational speed of the LiDAR's spinning unit is not sufficient to prevent ocular harm. The techniques and systems enable the LiDAR's spinning unit to act as a final safeguard for laser operations to ensure that the laser operates (e.g., produces light) only when the unit is spinning at a safe speed. The techniques and systems can offer protection against a malfunctioning or security-compromised LiDAR base unit which may command the spinning unit to activate the laser without rotating the spinning unit. The techniques and systems can be implemented within the spinning unit using low-cost inertial sensors. The techniques and systems can be implemented in hardware that minimizes or eliminates unauthorized tampering.

### System Overview

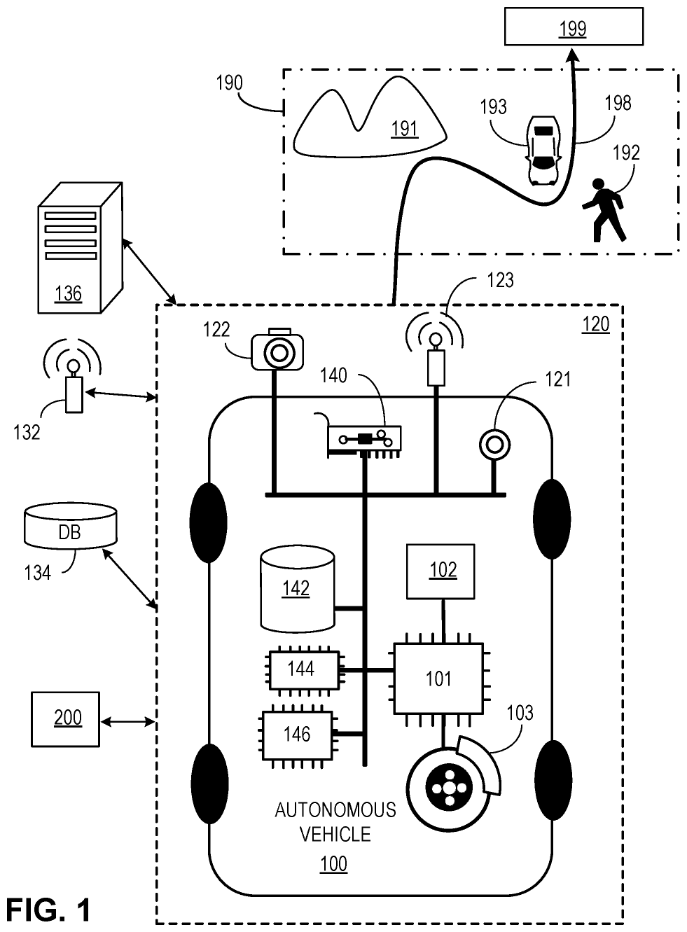

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, an AV system refers to the AV along with the array of hardware, software, stored data, and data generated in real-time that supports the operation of the AV. In an embodiment, the AV system is incorporated within the AV. In an embodiment, the AV system is spread across several locations.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Autonomous vehicles have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the vehicle 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

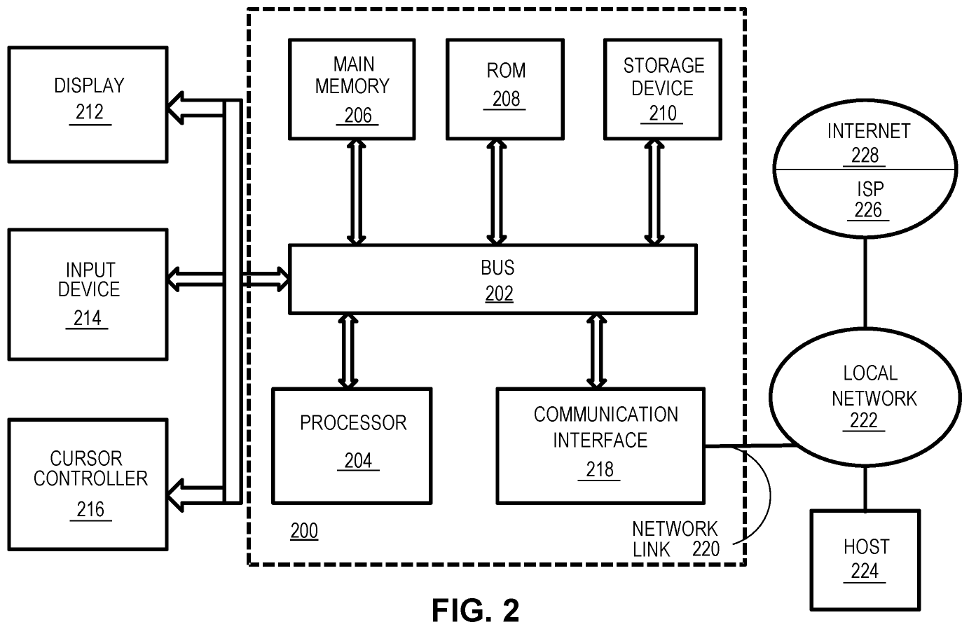

In an embodiment, the AV system 120 includes devices 101 that are instrumented to receive and act on operational commands from the computer processors 146. We use the term “operational command” to mean an executable instruction (or set of instructions) that causes a vehicle to perform an action (e.g., a driving maneuver). Operational commands can, without limitation, including instructions for a vehicle to start moving forward, stop moving forward, start moving backward, stop moving backward, accelerate, decelerate, perform a left turn, and perform a right turn. In an embodiment, computing processors 146 are similar to the processor 204 described below in reference to FIG. 2. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the vehicle 100, such as the AV's position, linear and angular velocity and acceleration, and heading (e.g., an orientation of the leading end of vehicle 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 208 or storage device 210 described below in relation to FIG. 2. In an embodiment, memory 144 is similar to the main memory 206 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the vehicle 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the vehicle 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 also stores and transmits digital data (e.g., storing data such as road and street locations). Such data is stored on the memory 144 on the vehicle 100, or transmitted to the vehicle 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data can be stored on the memory 144 on the vehicle 100, or transmitted to the vehicle 100 via a communications channel from the remotely located database 134.

Computer processors 146 located on the vehicle 100 algorithmically generate control actions based on both real-time sensor data and prior information, allowing the AV system 120 to execute its autonomous driving capabilities.

In an embodiment, the AV system 120 includes computer peripherals 132 coupled to computer processors 146 for providing information and alerts to, and receiving input from, a user (e.g., an occupant or a remote user) of the vehicle 100. In an embodiment, peripherals 132 are similar to the display 212, input device 214, and cursor controller 216 discussed below in reference to FIG. 2. The coupling is wireless or wired. Any two or more of the interface devices can be integrated into a single device.

In an embodiment, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In an embodiment, the privacy level specifies particular information associated with a passenger that is deleted once the ride is completed. In an embodiment, the privacy level specifies particular information associated with a passenger and identifies one or more entities that are authorized to access the information. Examples of specified entities that are authorized to access information can include other AVs, third party AV systems, or any entity that could potentially access the information.

A privacy level of a passenger can be specified at one or more levels of granularity. In an embodiment, a privacy level identifies specific information to be stored or shared. In an embodiment, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third party AV systems, etc.

In an embodiment, the AV system 120 or the cloud server 136 determines if certain information associated with a passenger can be accessed by the AV 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the AV 100, or to another AV. This enables the passenger's privacy level to specify which other entities are allowed to receive data about the passenger's actions or other data associated with the passenger.

FIG. 2 shows a computer system 200. In an implementation, the computer system 200 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or can include one or more general purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 200 includes a bus 202 or other communication mechanism for communicating information, and a processor 204 coupled with a bus 202 for processing information. The processor 204 is, for example, a general-purpose microprocessor. The computer system 200 also includes a main memory 206, such as a random-access memory (RAM) or other dynamic storage device, coupled to the bus 202 for storing information and instructions to be executed by processor 204. In one implementation, the main memory 206 is used for storing temporary variables or other intermediate information during execution of instructions to be executed by the processor 204. Such instructions, when stored in non-transitory storage media accessible to the processor 204, render the computer system 200 into a special-purpose machine that is customized to perform the operations specified in the instructions.

In an embodiment, the computer system 200 further includes a read only memory (ROM) 208 or other static storage device coupled to the bus 202 for storing static information and instructions for the processor 204. A storage device 210, such as a magnetic disk, optical disk, solid-state drive, or three-dimensional cross point memory is provided and coupled to the bus 202 for storing information and instructions.

In an embodiment, the computer system 200 is coupled via the bus 202 to a display 212, such as a cathode ray tube (CRT), a liquid crystal display (LCD), plasma display, light emitting diode (LED) display, or an organic light emitting diode (OLED) display for displaying information to a computer user. An input device 214, including alphanumeric and other keys, is coupled to bus 202 for communicating information and command selections to the processor 204. Another type of user input device is a cursor controller 216, such as a mouse, a trackball, a touch-enabled display, or cursor direction keys for communicating direction information and command selections to the processor 204 and for controlling cursor movement on the display 212. This input device typically has two degrees of freedom in two axes, a first axis (e.g., x-axis) and a second axis (e.g., y-axis), that allows the device to specify positions in a plane.

According to one embodiment, the techniques herein are performed by the computer system 200 in response to the processor 204 executing one or more sequences of one or more instructions contained in the main memory 206. Such instructions are read into the main memory 206 from another storage medium, such as the storage device 210. Execution of the sequences of instructions contained in the main memory 206 causes the processor 204 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 210. Volatile media includes dynamic memory, such as the main memory 206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 202. Transmission media can also take the form of acoustic or light waves, such as those generated during radio-wave and infrared data communications.

In an embodiment, various forms of media are involved in carrying one or more sequences of one or more instructions to the processor 204 for execution. For example, the instructions are initially carried on a magnetic disk or solid-state drive of a remote computer. The remote computer loads the instructions into its dynamic memory and send the instructions over a telephone line using a modem. A modem local to the computer system 200 receives the data on the telephone line and use an infrared transmitter to convert the data to an infrared signal. An infrared detector receives the data carried in the infrared signal and appropriate circuitry places the data on the bus 202. The bus 202 carries the data to the main memory 206, from which processor 204 retrieves and executes the instructions. The instructions received by the main memory 206 can optionally be stored on the storage device 210 either before or after execution by processor 204.

The computer system 200 also includes a communication interface 218 coupled to the bus 202. The communication interface 218 provides a two-way data communication coupling to a network link 220 that is connected to a local network 222. For example, the communication interface 218 is an integrated service digital network (ISDN) card, cable modem, satellite modem, or a modem to provide a data communication connection to a corresponding type of telephone line. As another example, the communication interface 218 is a local area network (LAN) card to provide a data communication connection to a compatible LAN. In some implementations, wireless links are also implemented. In any such implementation, the communication interface 218 sends and receives electrical, electromagnetic, or optical signals that carry digital data streams representing various types of information.

The network link 220 typically provides data communication through one or more networks to other data devices. For example, the network link 220 provides a connection through the local network 222 to a host computer 224 or to a cloud data center or equipment operated by an Internet Service Provider (ISP) 226. The ISP 226 in turn provides data communication services through the world-wide packet data communication network now commonly referred to as the “Internet” 228. The local network 222 and Internet 228 both use electrical, electromagnetic or optical signals that carry digital data streams. The signals through the various networks and the signals on the network link 220 and through the communication interface 218, which carry the digital data to and from the computer system 200, are example forms of transmission media.

The computer system 200 sends messages and receives data, including program code, through the network(s), the network link 220, and the communication interface 218. In an embodiment, the computer system 200 receives code for processing. The received code is executed by the processor 204 as it is received, and/or stored in storage device 210, or other non-volatile storage for later execution.

### Autonomous Vehicle Architecture

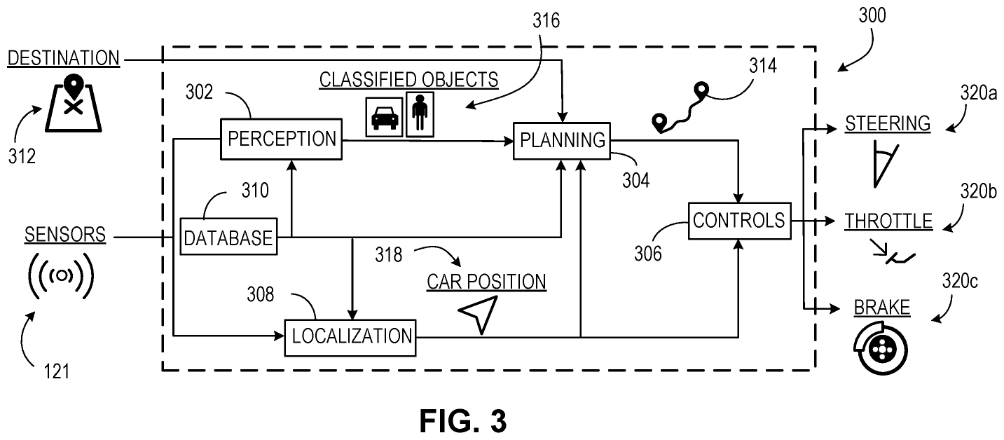

FIG. 3 shows an example architecture 300 for an autonomous vehicle (e.g., the vehicle 100 shown in FIG. 1). The architecture 300 includes a perception module 302 (sometimes referred to as a perception circuit), a planning module 304 (sometimes referred to as a planning circuit), a control module 306 (sometimes referred to as a control circuit), a localization module 308 (sometimes referred to as a localization circuit), and a database module 310 (sometimes referred to as a database circuit). Each module plays a role in the operation of the vehicle 100. Together, the modules 302, 304, 306, 308, and 310 can be part of the AV system 120 shown in FIG. 1. In some embodiments, any of the modules 302, 304, 306, 308, and 310 is a combination of computer software (e.g., executable code stored on a computer-readable medium) and computer hardware (e.g., one or more microprocessors, microcontrollers, application-specific integrated circuits (ASICs)), hardware memory devices, other types of integrated circuits, other types of computer hardware, or a combination of any or all of these things). Each of the modules 302, 304, 306, 308, and 310 is sometimes referred to as a processing circuit (e.g., computer hardware, computer software, or a combination of the two). A combination of any or all of the modules 302, 304, 306, 308, and 310 is also an example of a processing circuit.

In use, the planning module 304 receives data representing a destination 312 and determines data representing a trajectory 314 (sometimes referred to as a route) that can be traveled by the vehicle 100 to reach (e.g., arrive at) the destination 312. In order for the planning module 304 to determine the data representing the trajectory 314, the planning module 304 receives data from the perception module 302, the localization module 308, and the database module 310.

The perception module 302 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 316 is provided to the planning module 304.

The planning module 304 also receives data representing the AV position 318 from the localization module 308. The localization module 308 determines the AV position by using data from the sensors 121 and data from the database module 310 (e.g., a geographic data) to calculate a position. For example, the localization module 308 uses data from a GNSS (Global Navigation Satellite System) sensor and geographic data to calculate a longitude and latitude of the AV. In an embodiment, data used by the localization module 308 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high-precision maps are constructed by adding data through automatic or manual annotation to low-precision maps.

The control module 306 receives the data representing the trajectory 314 and the data representing the AV position 318 and operates the control functions 320a-c (e.g., steering, throttling, braking, ignition) of the AV in a manner that will cause the vehicle 100 to travel the trajectory 314 to the destination 312. For example, if the trajectory 314 includes a left turn, the control module 306 will operate the control functions 320a-c in a manner such that the steering angle of the steering function will cause the vehicle 100 to turn left and the throttling and braking will cause the vehicle 100 to pause and wait for passing pedestrians or vehicles before the turn is made.

### Autonomous Vehicle Inputs

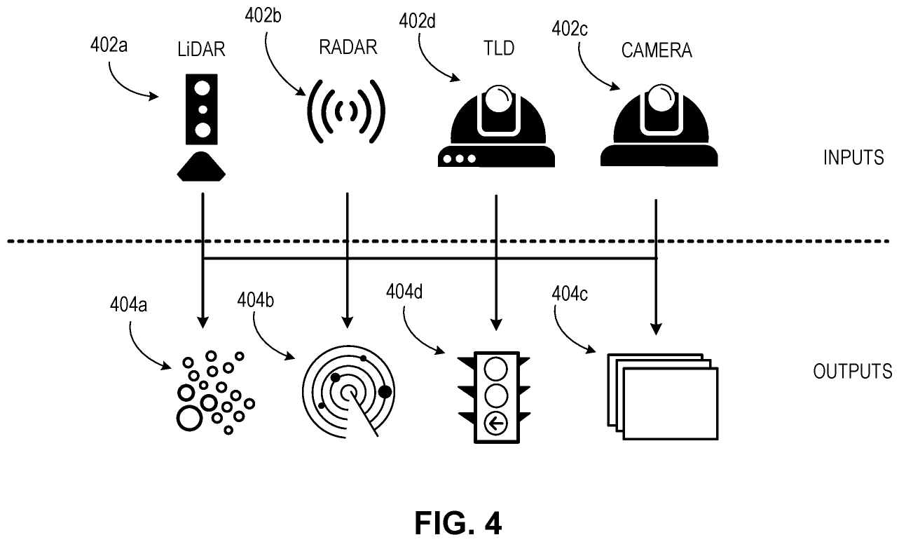

FIG. 4 shows an example of inputs 402a-d (e.g., sensors 121 shown in FIG. 1) and outputs 404a-d (e.g., sensor data) that is used by the perception module 302 (FIG. 3). One input 402a is a LiDAR (Light Detection and Ranging) system (e.g., LiDAR 123 shown in FIG. 1). LiDAR is a technology that uses laser light (e.g., bursts of light such as infrared light or light at other optical waveforms) to obtain data about physical objects in its line of sight. A LiDAR system produces LiDAR data as output 404a. For example, LiDAR data is collections of 3D or 2D points (also known as a point clouds) that are used to construct a representation of the environment 190.

Another input 402b is a RADAR system. RADAR is a technology that uses radio waves to obtain data about nearby physical objects. RADARs can obtain data about objects not within the line of sight of a LiDAR system. A RADAR system produces RADAR data as output 404b. For example, RADAR data are one or more radio frequency electromagnetic signals that are used to construct a representation of the environment 190.

Another input 402c is a camera system. A camera system uses one or more cameras (e.g., digital cameras using a light sensor such as a charge-coupled device [CCD]) to obtain information about nearby physical objects. A camera system produces camera data as output 404c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In some embodiments, the camera system is configured to “see” objects far, e.g., up to a kilometer or more ahead of the AV. Accordingly, in some embodiments, the camera system has features such as sensors and lenses that are optimized for perceiving objects that are far away.

Another input 402d is a traffic light detection (TLD) system. A TLD system uses one or more cameras to obtain information about traffic lights, street signs, and other physical objects that provide visual navigation information. A TLD system produces TLD data as output 404d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the vehicle 100 has access to all relevant navigation information provided by these objects. For example, the viewing angle of the TLD system is about 120 degrees or more.

In some embodiments, outputs 404a-d are combined using a sensor fusion technique. Thus, either the individual outputs 404a-d are provided to other systems of the vehicle 100 (e.g., provided to a planning module 304 as shown in FIG. 3), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

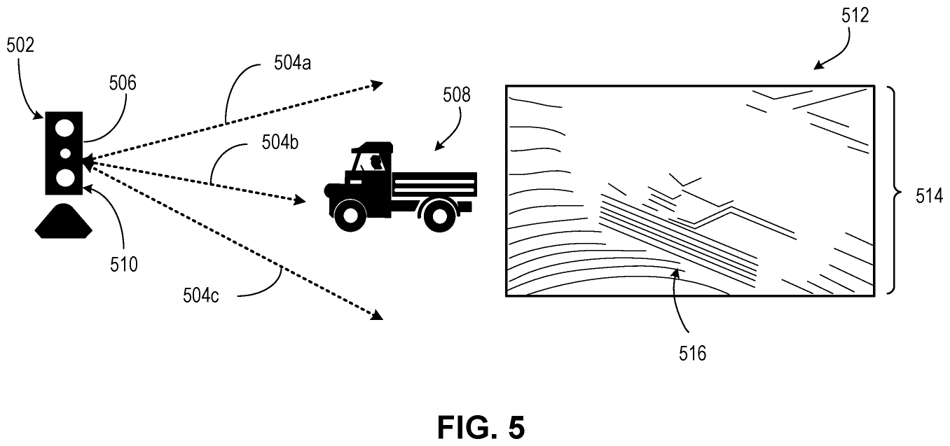

FIG. 5 shows an example of a LiDAR system 502 (e.g., the input 402a shown in FIG. 4). The LiDAR system 502 emits light 504a-c from a light emitter 506 (e.g., a laser transmitter). Light emitted by a LiDAR system is typically not in the visible spectrum; for example, infrared light is often used. Some of the light 504b emitted encounters a physical object 508 (e.g., a vehicle) and reflects back to the LiDAR system 502. (Light emitted from a LiDAR system typically does not penetrate physical objects, e.g., physical objects in solid form.) The LiDAR system 502 also has one or more light detectors 510, which detect the reflected light. In an embodiment, one or more data processing systems associated with the LiDAR system generates an image 512 representing the field of view 514 of the LiDAR system. The image 512 includes information that represents the boundaries 516 of a physical object 508. In this way, the image 512 is used to determine the boundaries 516 of one or more physical objects near an AV.

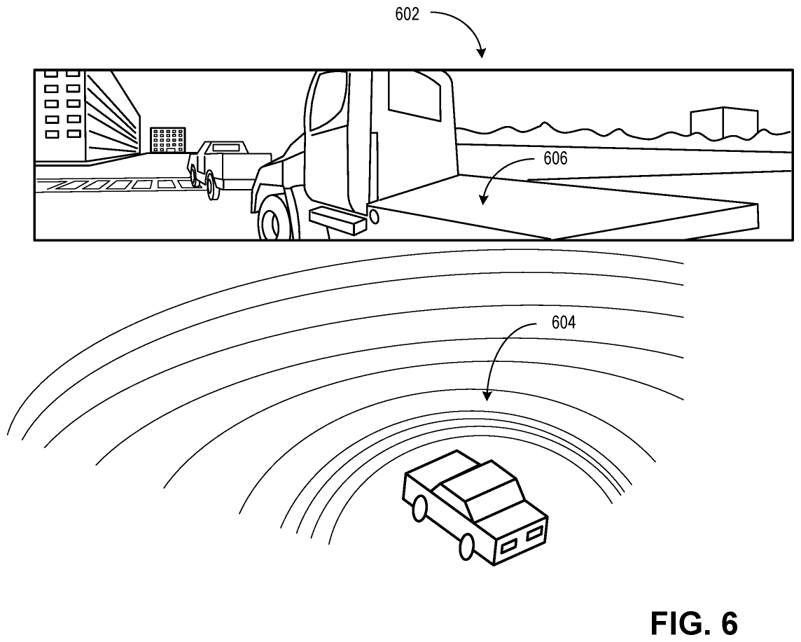

FIG. 6 shows the LiDAR system 502 in operation. In the scenario shown in this figure, the vehicle 100 receives both camera system output 404c in the form of an image 602 and LiDAR system output 404a in the form of LiDAR data points 604. In use, the data processing systems of the vehicle 100 compares the image 602 to the data points 604. In particular, a physical object 606 identified in the image 602 is also identified among the data points 604. In this way, the vehicle 100 perceives the boundaries of the physical object based on the contour and density of the data points 604.

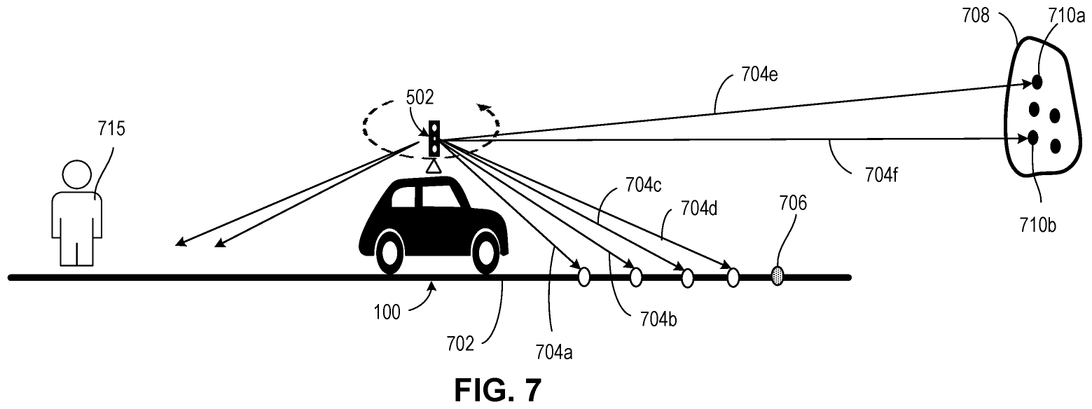

FIG. 7 shows the operation of the LiDAR system 502 in additional detail. As described above, the vehicle 100 detects the boundary of a physical object based on characteristics of the data points detected by the LiDAR system 502. In an embodiment, the LiDAR system 502 can be mounted to the roof of vehicle 100 and perform 360 degree scanning of its surroundings. While scanning, the laser of the LiDAR system 502 is kept spinning in a rotational plane to perform continuous 360 degree scans. Scanning outputs can be used to detect other cars, ground 702, objects 708, and pedestrians 715. As shown in FIG. 7, a flat object, such as the ground 702, will reflect light 704a-d emitted from a LiDAR system 502 in a consistent manner. Put another way, because the LiDAR system 502 emits light using consistent spacing, the ground 702 will reflect light back to the LiDAR system 502 with the same consistent spacing. As the vehicle 100 travels over the ground 702, the LiDAR system 502 will continue to detect light reflected by the next valid ground point 706 if nothing is obstructing the road. However, if an object 708 obstructs the road, light 704e-f emitted by the LiDAR system 502 will be reflected from points 710a-b in a manner inconsistent with the expected consistent manner. From this information, the vehicle 100 can determine that the object 708 is present.

### LiDAR Safety Mechanism

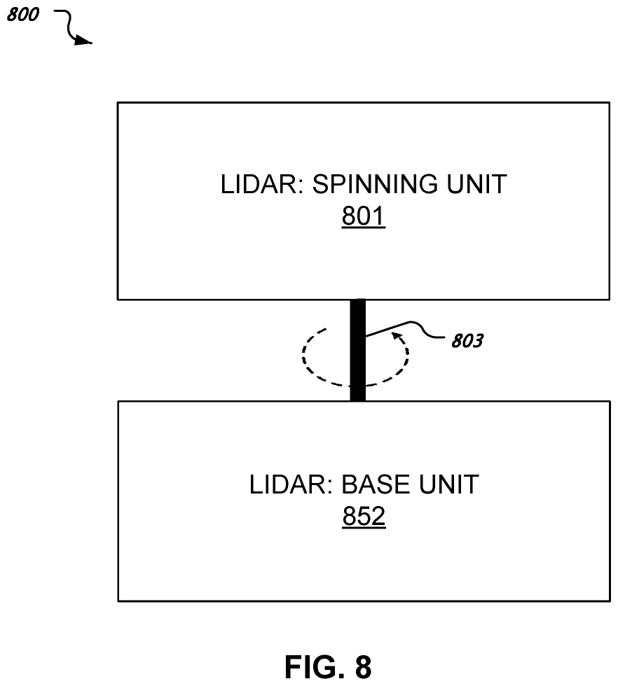

FIG. 8 shows an example of an architecture of a LiDAR system 800 that includes a spinning unit 801 and a base unit 852. The LiDAR system 800 can be coupled with a vehicle, such as vehicle 100. However, the LiDAR system 800 can also be a standalone system that does not require a vehicle, such as one used in a portable mapping system. In this example, the spinning unit 801 and the base unit 852 are mechanically coupled via a shaft 803 such that the base unit 852 can rotate the spinning unit 801 via the shaft 803. Other types of couplings are possible.

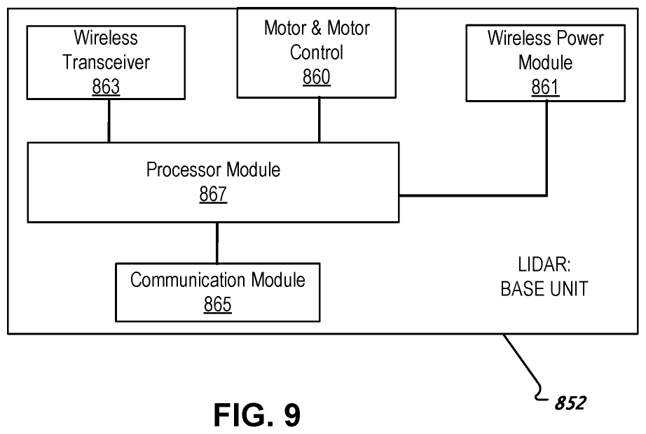

FIG. 9 shows an example of an architecture of the LiDAR base unit 852 of FIG. 8. The base unit 852 can include a processor module 867, communication module 865, wireless power module 861, a motor and motor control module 860, and a wireless transceiver 863. The processor module 867 can include one or more ASICs, FPGAs, processors, or a combination thereof. The wireless power module 861 of the base unit 852 can provide power to the spinning unit 801. The base unit 852 can communicate with the spinning unit 801 via a wireless transceiver 826 via an interface such as Wi-Fi (e.g., IEEE 802.11), Bluetooth, optical, or another type of interface. The interface can be based on a public standard such as 802.11 or Bluetooth or can be based on a proprietary design. Other types of interfaces are possible.

The communication module 865 can use a wireless or wired interface to communicate with an external source such as the vehicle 100. The processor module 867 can receive a command from the external source to commence imaging. The processor module 867 can cause the motor and motor control module 860 to start spinning the spinning unit 801 and subsequently issue a command to the spinning unit 801 to activate its laser. The processor module 867 can process imagery data from the spinning unit 801 and relay the data to the external source.

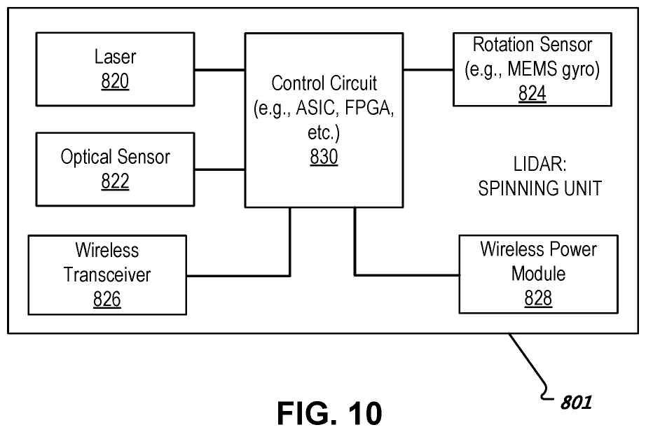

FIG. 10 shows an example of an architecture of the LiDAR spinning unit 801 of FIG. 8. The spinning unit 801 can include a control circuit 830, a rotation sensor 824, wireless power module 828, wireless transceiver 826, optical sensor 822, and a laser 820. The control circuit 830 can include circuitry such as an ASIC, FPGA, or a processor. The rotation sensor 824 can include a micro-electro-mechanical systems (MEMS) gyroscope (MEMS gyro) that detects rotation in one or more rotational planes. Other types of rotation sensors are possible, such as a precision cell integrating (PCI) gyro or fiber-optic and ring-laser gyros

The wireless power module 828 can obtain power from the base unit 852 and distribute it throughout the spinning unit 801. The wireless power module 828 can include a rechargeable battery. The laser 820 can be configured to beam laser light into an environment surrounding the spinning unit 801. The optical sensor 822 can receive the reflections of the laser light to create imagery data, and provide the imagery data to the base unit 852 via the wireless transceiver 826.

The control circuit 830 can be configured to receive a command from the processor module 867 to activate the laser 820 via the wireless transceiver 826. Before activating the laser 820, the control circuit 830 can be configured to check the rotational speed of the spinning unit. The control circuit 830 can determine whether a rotational speed of the spinning unit 801 is greater than or equal to a minimum rotational speed threshold based on an output of the rotation sensor 824. The minimum rotational speed threshold can be based on a power output rating for the laser. In an embodiment, the minimum rotational speed threshold is sufficient to cause the spinning unit 801 to rotate the laser 820 such that a predetermined ocular safety power output criterion, such as power requirements for a Class I laser device, is satisfied while the spinning unit 801 is rotating and the laser 820 is activated. In an embodiment, the minimum rotational speed threshold is at least 600 RPMs (revolutions per minute). In another embodiment, the minimum rotational speed threshold is set to 1200 RPMs. Different threshold RPM values are possible. Also, different units for expressing a rotational speed are possible such as radians per minute. The control circuit 830 can store the minimum rotational speed threshold in a non-volatile memory within or connected with the control circuit 830. In an embodiment, the minimum rotational speed threshold is permanently encoded in a logic circuit of the control circuit 830 such that it cannot be altered or overridden by the base unit 852 or other external sources.

The control circuit 830 can activate the laser 820 to produce a laser output in response to the command if the rotational speed is sufficient. For example, this activation can be based on a determination that the rotational speed of the spinning unit 801 is greater than or equal to the minimum rotational speed threshold. Activating the laser 820 to produce a laser output can include supplying power to the laser 820, providing an appropriate activation control input signal, or both. The control circuit 830 can be configured to obtain sensor measurements from the rotation sensor 824 while the laser 820 is activated. Using at least one of the sensor measurements, the control circuit 830 can be configured to suspend operation of the laser 820 based on a determination that the rotational speed of the spinning unit 801 apparatus is less than the minimum rotational speed threshold. The control circuit 830 can continue sampling while laser operations are suspended, and resume the laser operations once the rotational speed is equal to or greater than the minimum rotational speed threshold.

The control circuit 830 can be configured to provide status information to the base unit 852 via transceiver 826. Status information can include whether the laser 820 has been activated, rotational speed, whether a laser activation command is successful, whether there has been a suspension of laser operations due to insufficient rotational speed, etc. Other and different types of status information can be provided. In an embodiment, multiple rotation sensors 824 can be used, and the control circuit 830 can use a voting mechanism or averaging mechanism based on multiple data points from respective sensors to determine whether there is sufficient rotational speed. In an embodiment, multiple types of Inertial Measurement Unit (IMU) sensors can be used to determine rotational speed. In an embodiment, the control circuit 830 can perform sensor data adjustments to compensate for drift.

In an embodiment, a control circuit can be configured to receive a command to activate the laser; in response to receiving the command, compare an output of the rotation sensor with a minimum rotational speed, and activate the laser based on a result of the comparing. Comparing an output of the rotation sensor with a minimum rotational speed can include determining a measured rotational speed based on the output of the rotation sensor and comparing the measured rotational speed with the minimum rotational speed. The comparing can include determining whether the measured rotational speed is greater than or equal to the minimum rotational speed threshold.

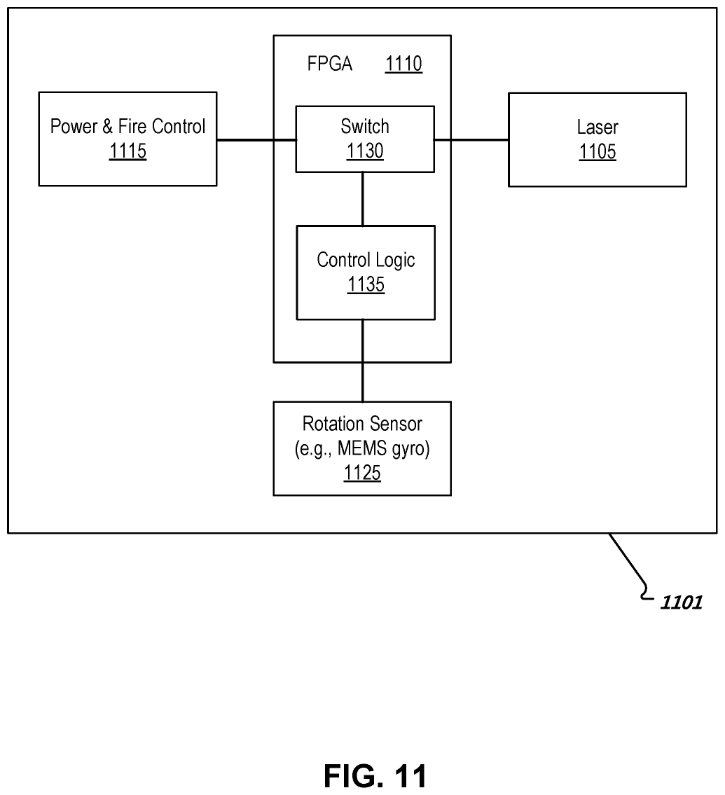

FIG. 11 shows another example of an architecture of a LiDAR spinning unit 1101. In this example, some LiDAR components such as the optical sensor is omitted for simplification. The LiDAR spinning unit 1101 includes a laser 1105, FPGA 1110, rotation sensor 1125, and power and fire control circuitry 1115. The FPGA 1110 includes control logic 1135 coupled with a switch 1130 that is positioned between the power and fire control circuitry 1115 and the laser 1105. In this example, the switch 1130 is included as part of the FPGA 1110, however, the switch 1130 can be located off of the FPGA 1110. Based on a rotational speed measurement from the rotation sensor 1125, the control logic 1135 can cause the switch 1130 to transition to the on state, which completes the circuit between the power and fire control circuitry 1115 and the laser 1105, and in turn causes the laser 1105 to produce a laser output.

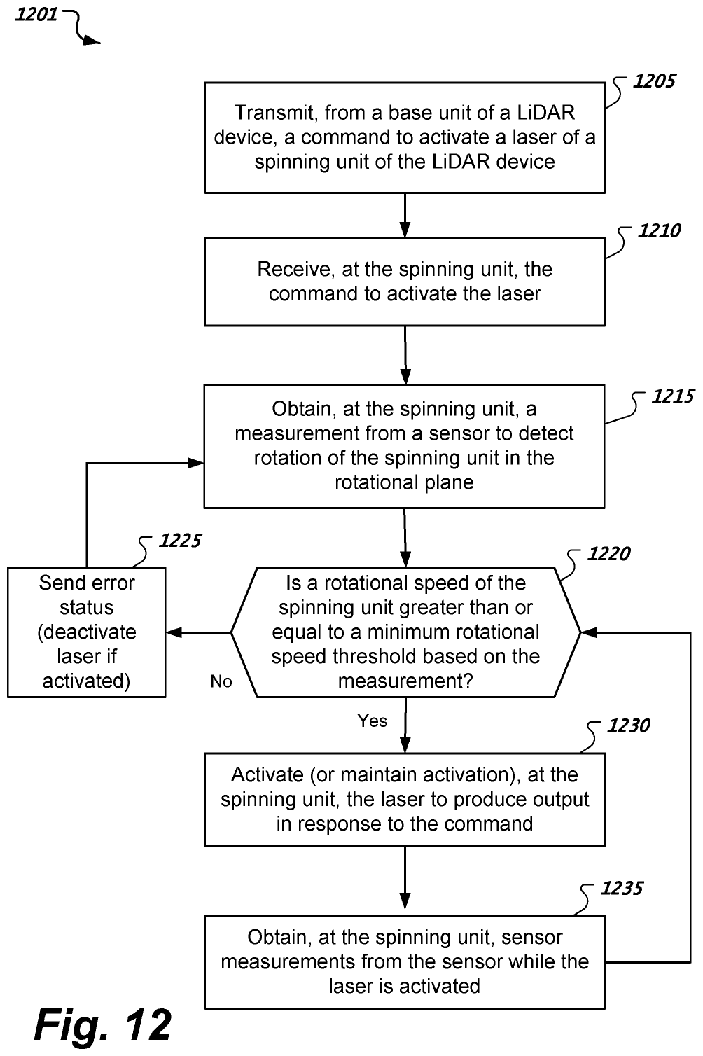

FIG. 12 shows a flowchart of an example of a process 1201 that performs a safety check before activating the laser of a LiDAR. The process 1201 can be performed by a processor module such as processor module 867 of FIG. 9 of a LiDAR's base unit and by a control circuit such as control circuit 830 of FIG. 10 of a LiDAR's spinning unit. At 1205, the processor module in the base unit transmits a command to activate a laser of the LiDAR's spinning unit. Communications between the spinning unit and the base unit can occur wirelessly.

At 1210, the control circuit of the spinning unit receives the command to activate the laser. At 1215, the control circuit obtains a measurement from a sensor to detect rotation of the spinning unit in the rotational plane. Obtaining a measurement can include receiving a sensor event from a sensor, polling a sensor for sensor data, or monitoring voltage on a line coupled with the sensor. Other technique for obtaining sensor measurements are possible.

At 1220, the control circuit determines whether a rotational speed of the spinning unit is greater than or equal to a minimum rotational speed threshold based on the measurement. In an embodiment, the control circuit can perform one or more calculations to convert a sensor measurement (e.g., angular rate) into a rotational speed measurement (e.g., RPM). If the control circuit determines that the rotational speed of the spinning unit is less than the minimum rotational speed, the control circuit, at 1225, can send an error status to the base unit. In an embodiment, the control circuit is configured to provide status information to the base unit when the spinning unit is not allowed to perform the command based on a determination that the rotational speed of the spinning unit is less than the minimum rotational speed threshold. Status information can include a status value indicating that the spinning unit is not spinning or is spinning at too slow of a rotational speed.

Otherwise, if the rotational speed of the spinning unit is greater than or equal to the minimum rotational speed, then at 1230, the control circuit activates the laser to produce output in response to the command. While activated, the control circuit can perform additional checks of the rotational speed. The control circuit can obtain the sensor measurements periodically, e.g., every 0.1, 0.5, 1, or 2 seconds. At 1235, the control circuit can obtain one or more sensor measurements from the sensor while the laser is activated. The rotational speed is checked again at 1220, and if greater than or equal to the minimum rotational speed threshold, the control circuit can maintain the laser activation at 1230. Otherwise, the control circuit can send an error status and deactivate the laser at 1225. In an embodiment, the control circuit is configured to suspend laser operation based on a single measurement that indicates a rotational speed that is less than the minimum. In another embodiment, the control circuit is configured to suspend laser operation based on a rolling average of the last N samples, where N is an integer greater than 1, indicating than the averaged rotational speed is less than the minimum.

In the foregoing description, embodiments of the inventions have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. An apparatus comprising:
a laser, wherein the apparatus is configured to rotate the laser in a rotational plane;
a sensor to detect rotation of the apparatus in the rotational plane; and
a control circuit configured to:
receive a command to activate the laser,
determine whether a rotational speed of the apparatus is greater than or equal to a minimum rotational speed threshold based on an output of the sensor, and
activate the laser to produce output in response to the command based on a determination that the rotational speed of the apparatus is greater than or equal to the minimum rotational speed threshold.

2. The apparatus of claim 1, wherein the control circuit is configured to obtain sensor measurements from the sensor while the laser is activated, and suspend operation of the laser based on a determination using at least one of the sensor measurements that the rotational speed of the apparatus is less than the minimum rotational speed threshold.

3. The apparatus of claim 1, wherein the apparatus is coupled with a base unit configured to rotate the apparatus, wherein the control circuit is configured to receive the command from the base unit.

4. The apparatus of claim 3, wherein the control circuit is configured to provide status information to the base unit when the apparatus is not allowed to perform the command based on a determination that the rotational speed of the apparatus is less than the minimum rotational speed threshold.

5. The apparatus of claim 1, wherein the minimum rotational speed threshold is sufficient to cause the apparatus to rotate the laser such that a predetermined ocular safety power output criterion is satisfied while the apparatus is rotating and the laser is activated.

6. The apparatus of claim 1, wherein the minimum rotational speed threshold is at least 600 revolutions per minute.

7. The apparatus of claim 1, wherein the sensor comprises a micro-electro-mechanical systems (MEMS) gyroscope.

8. A system comprising:
a spinning unit comprising a laser, the spinning unit configured to configured to rotate the laser in a rotational plane; and
a base unit coupled with the spinning unit, the base unit comprising a motor to rotate the spinning unit in the rotational plane and a processor configured to send a command to activate the laser,
wherein the spinning unit further comprises:
a sensor to detect rotation of the spinning unit in the rotational plane; and
a control circuit configured to:
receive the command to activate the laser,
determine whether a rotational speed of the spinning unit is greater than or equal to a minimum rotational speed threshold based on an output of the sensor, and
activate the laser to produce output in response to the command based on a determination that the rotational speed of the spinning unit is greater than or equal to the minimum rotational speed threshold.

9. The system of claim 8, wherein the control circuit is configured to obtain sensor measurements from the sensor while the laser is activated, and suspend operation of the laser based on a determination using at least one of the sensor measurements that the rotational speed of the spinning unit is less than the minimum rotational speed threshold.

10. The system of claim 8, wherein the control circuit is configured to provide status information to the base unit when the spinning unit is not allowed to perform the command based on a determination that the rotational speed of the spinning unit is less than the minimum rotational speed threshold.

11. The system of claim 8, wherein the minimum rotational speed threshold is sufficient to cause the spinning unit to rotate the laser such that a predetermined ocular safety power output criterion is satisfied while the spinning unit is rotating and the laser is activated.

12. The system of claim 8, wherein the minimum rotational speed threshold is at least 600 revolutions per minute.

13. The system of claim 8, wherein the sensor comprises a micro-electro-mechanical systems (MEMs) gyroscope.

14. A method comprising:
transmitting, from a base unit of a LIDAR system, a command to activate a laser of a spinning unit of the LIDAR system, the spinning unit configured to configured to rotate the laser in a rotational plane;
receiving, at the spinning unit, the command to activate the laser;
obtaining, at the spinning unit, a measurement from a sensor to detect rotation of the spinning unit in the rotational plane;
determining, at the spinning unit, whether a rotational speed of the spinning unit is greater than or equal to a minimum rotational speed threshold based on the measurement; and
activating, at the spinning unit, the laser to produce output in response to the command based on a determination that the rotational speed of the spinning unit is greater than or equal to the minimum rotational speed threshold.

15. The method of claim 14, comprising:
obtaining, at the spinning unit, sensor measurements from the sensor while the laser is activated; and
suspending, at the spinning unit, operation of the laser based on a determination using at least one of the sensor measurements that the rotational speed of the spinning unit is less than the minimum rotational speed threshold.

16. The method of claim 14, comprising:
providing, by the spinning unit to the base unit, status information when the spinning unit is not allowed to perform the command based on a determination that the rotational speed of the spinning unit is less than the minimum rotational speed threshold.

17. The method of claim 14, wherein the minimum rotational speed threshold is sufficient to cause the spinning unit to rotate the laser such that a predetermined ocular safety power output criterion is satisfied while the spinning unit is rotating and the laser is activated.

18. The method of claim 14, wherein the minimum rotational speed threshold is at least 600 revolutions per minute.

19. The method of claim 14, wherein the sensor comprises a micro-electro-mechanical systems (MEMS) gyroscope.

20. A non-transitory computer-readable storage medium comprising at least one program for execution by at least one processor of a device, the at least one program including instructions which, when executed by the at least one processor, cause the device to perform the method of claim 14.
